(19) United States
(12) Patent Application Publication
(10) Pub. No.: US 2013/0091027 A1
(43) Pub. Date: Apr. 11, 2013

(54) ADVERTISING CAPTCHA SYSTEM AND METHOD

(71) Applicant: Wei-Chih Lin, Taichung City (TW)

(72) Inventor: Wei-Chih Lin, Taichung City (TW)

(21) Appl. No.: 13/486,402

(22) Filed: Jun. 1, 2012

(30) Foreign Application Priority Data
Oct. 7, 2011 (TW) 100136418

(51) Int. Cl. G06Q 30/02

(52) U.S. Cl. 705/14.73

(57) ABSTRACT

An advertising CAPTCHA system in accordance with the present invention is used in a designated display with at least one user and comprises a CAPTCHA server connected to the designated display, stores multiple advertising CAPTCHAs, comprises a CAPTCHA module and transmits the advertising CAPTCHAs to the designated display, wherein each advertising CAPTCHA comprises a guiding zone and an advertisement comprising a responding zone corresponding to the guiding zone, the CAPTCHA module has a clicking threshold, determines whether or not the user clicks the responding zone and determines if the user achieves the clicking threshold, the user passes the advertising CAPTCHA if the user achieves the clicking threshold, and the CAPTCHA server transmits another advertising CAPTCHA to the designated display if the user does not achieve the clicking threshold.

### CROSS-REFERENCE TO RELATED APPLICATION

This application claims priority from application No. 100136418, filed on Oct. 7, 2011 in the Taiwan Intellectual Property Office.

### FIELD OF THE INVENTION

The present invention is an advertising Completely Automated Public Turing test to tell Computers and Humans Apart (CAPTCHA) system and method.

### BACKGROUND OF THE INVENTION

A CAPTCHA is a challenge-response test used in computing to ensure that a response is generated by a person. The process usually involves a server asking a user to complete a simple test that a computer generates and grades. Because computers are assumed to be unable to solve the CAPTCHA, any user entering a correct response is presumed to be human. Thus, it is sometimes described as a reverse Turing test, because it is administered by a machine and targeted at a human, in contrast to the standard Turing test that is typically administered by a human and targeted at a machine. A common CAPTCHA requires the user to type letters or digits from a distorted image that appears on a screen.

U.S. Pat. No. 7,680,891 discloses a method and system of spam control for content creation systems that includes evaluation of documents created by a creator for characteristics associated with spam. A challenge rate is determined based on the evaluation. Whenever the creator attempts to create a document, he or she may be presented a challenge in accordance with the challenge rate. The challenge rate may be adjusted based on the creator's response to the challenge.

However, the foregoing CAPTCHA causes a user to waste a lot of time to recognize the distorted image and only applies to recognize a human and computer.

U.S. Patent No. 20080133321 discloses an improved system and method for providing and using captchas for online advertising. An advertisement may be received, embedded in a captcha and stored for use in online advertising. A question about the advertisement may also be stored along with a valid answer for use in verifying a user has received an impression of the advertisement. In response to a request received for sending a captcha with an embedded advertisement to a web browser operating on a client, a captcha with an embedded advertisement may be selected and sent to the web browser for display as part of a web page.

U.S. Patent No. 20080133347 discloses an improved system and method for providing and using captchas for online advertising. An advertisement may be received, embedded in a captcha and stored for use in online advertising. A question about the advertisement may also be stored along with a valid answer for use in verifying a user has received an impression of the advertisement. In response to a request received for sending a captcha with an embedded advertisement to a web browser operating on a client, a captcha with an embedded advertisement may be selected and sent to the web browser for display as part of a web page. Upon verifying the response to the question from the user is a valid answer, receipt of an impression of the advertisement may be recorded. Additionally, the awareness of an online advertisement may be measured for a target audience and reported to advertisers.

U.S. Patent No. 20090012855 discloses a method of using advertisements in a Completely Automatic Public Turing test to tell Computers and Humans Apart (CAPTCHA) challenge/response transaction. In accordance with one aspect, a server allows access to some resource if the response to the ad/CAPTCHA challenge is an acceptable response.

However, the foregoing CAPTCHA causes a user to waste a lot of time to input the valid answer.

Accordingly, a new CAPTCHA system and an operational method are needed to overcome the foregoing problems.

### SUMMARY OF THE INVENTION

A first objective of the present invention allows a user to intuitively recognize and to input a CAPTCHA.

A second objective of the present invention increases functions of a CAPTCHA.

An advertising CAPTCHA system in accordance with the present invention is used in a designated display with at least one user, comprises a CAPTCHA server connected to the independent display page, stores multiple advertising CAPTCHAs, comprises a CAPTCHA module and transmits the advertising CAPTCHAs to the independent display page. Each advertising CAPTCHA comprises an advertisement and a guiding zone. The advertisement comprises a responding zone. The responding zone corresponds to the guiding zone. The CAPTCHA module has a clicking threshold, determines whether or not the user of the designated display clicks the responding zone and determines whether the user achieves the clicking threshold. The user passes the advertising CAPTCHA if the user achieves the clicking threshold. The CAPTCHA server transmits another advertising CAPTCHA to the designated display if the user does not achieve the clicking threshold.

An advertising CAPTCHA method in accordance with the present invention is used in a designated display and a CAPTCHA server with at least one user. The CAPTCHA server stores multiple advertising CAPTCHAs and has a clicking threshold. Each advertising CAPTCHA comprises an advertisement and a guiding zone. The advertisement comprises a responding zone corresponding to the guiding zone. The advertising CAPTCHA method comprises steps of transmitting an advertising CAPTCHA to the independent display page, clicking the advertisement corresponding to the guiding zone by the user, determining whether or not the user clicks the responding zone, transmitting another advertising CAPTCHA to the designated display when the user does not click the responding zone, determining whether or not the user achieves the clicking threshold, determining whether or not the user passes the advertising CAPTCHA if the user achieves the clicking threshold and transmitting another advertising CAPTCHA to the designated display when the user does not achieve the clicking threshold.

### BRIEF DESCRIPTION OF THE DRAWINGS

FIG. 1 is a functional block diagram of a first embodiment of an advertising CAPTCHA system in accordance with the present invention;

FIG. 2 is a functional block diagram of a second embodiment of an advertising

CAPTCHA system in accordance with the present invention;

FIG. 3 is a first embodiment of an advertising CAPTCHA in accordance with the present invention;

FIG. 4 is a flowchart of a first embodiment of an advertising CAPTCHA method in accordance with the present invention; and

FIG. 5 is a flowchart of a second embodiment of an advertising CAPTCHA method in accordance with the present invention.

### DETAILED DESCRIPTION OF THE PRESENT INVENTION

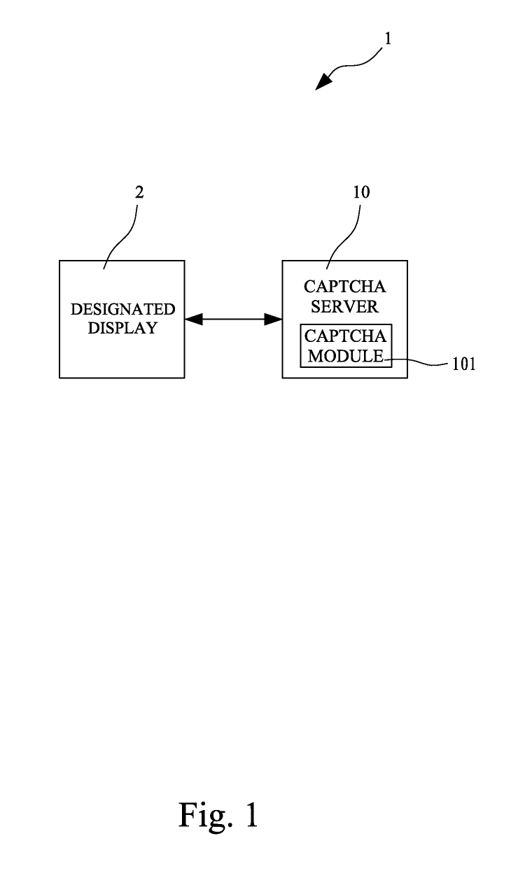

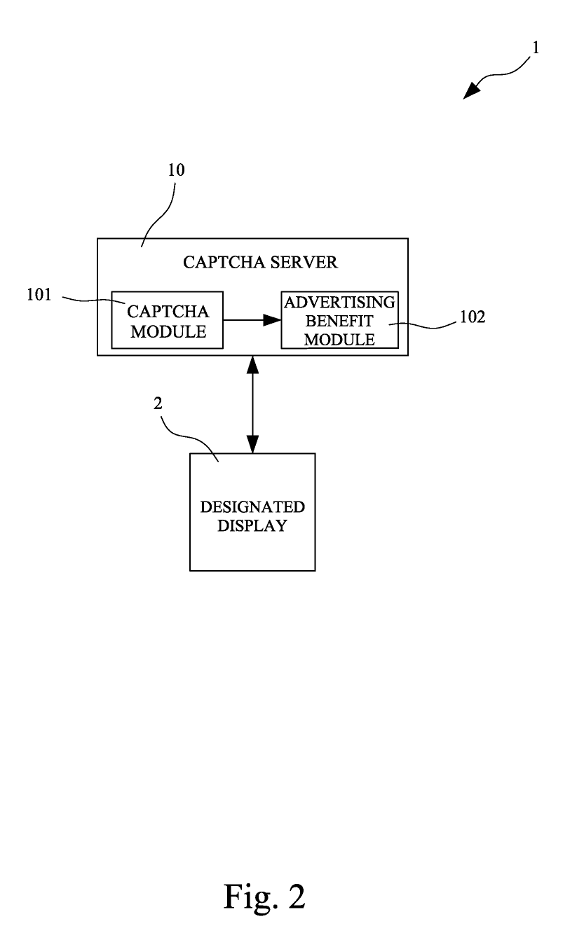

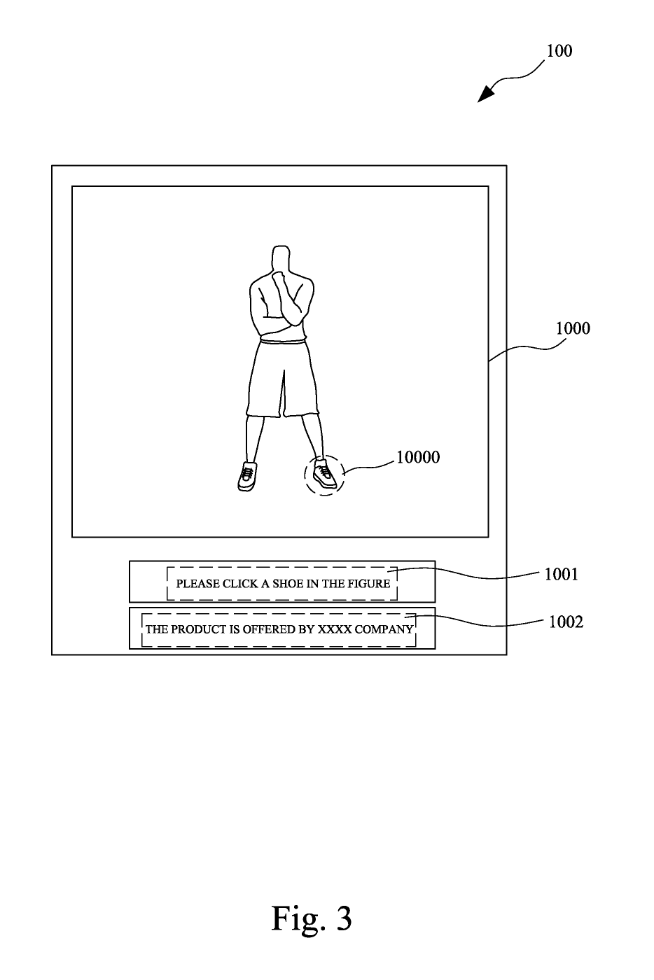

With reference to FIGS. 1 to 3, an advertising CAPTCHA system (1) in accordance with the present invention is used in a designated display (2) with at least one user and comprises a CAPTCHA server (10).

The designated display (2) may be a web page or a program screen.

The CAPTCHA server (10) connects to the designated display (2), stores multiple advertising CAPTCHAs (100),d comprises a CAPTCHA module (101), transmits the advertising CAPTCHAs (100) to the designated display (2) and may comprise an advertising benefit module (102).

Each advertising CAPTCHA (100) comprises an advertisement (1000) and a guiding zone (1001) and may comprise an advertising information zone (1002).

The advertisement (1000) comprises a responding zone (10000) and may be a picture, a video or a motion picture. The responding zone (10000) corresponds to the guiding zone (1001). The advertising information zone (1002) is a product linkage or information about a manufacturer.

The CAPTCHA module (101) has a clicking threshold, determines whether or not the user of the designated display (2) clicks the responding zone (10000), determines whether or not the user achieves the clicking threshold and may calculate a successful clicking number, a unsuccessful clicking number and a successful clicking ratio and may determine whether or not a number of clicks the user clicks in the responding zone (10000) is successfully over the clicking threshold.

The clicking threshold may be 1 and be increased when the user clicks the responding zone (10000) unsuccessfully.

The successful clicking number calculates a number of the user clicking the responding zone (10000) successfully. The unsuccessful clicking number calculates a number of the user calculating the responding zone (10000) unsuccessfully. The clicking success ratio is a ratio of the successful clicking number to the unsuccessful clicking number, is calculated for each advertising CAPTCHA (100) and is transmitted to the advertising benefit module ( 102) by the CAPTCHA module (101).

The advertising benefit module (102) is connected to the CAPTCHA module (101) and may calculate and save an overall success ratio and at least one designated display user success ratio.

The overall success ratio is a ratio of the successful clicking number to the unsuccessful clicking number of all users. The designated display user success ratio is a ratio of the successful clicking number to the unsuccessful clicking number of all users in each designated display (2).

The user passes the advertising CAPTCHA (100) if the user achieves the clicking threshold, and the CAPTCHA server (10) transmits another advertising CAPTCHA (100) to the designated display (2) if the user does not achieve the clicking threshold.

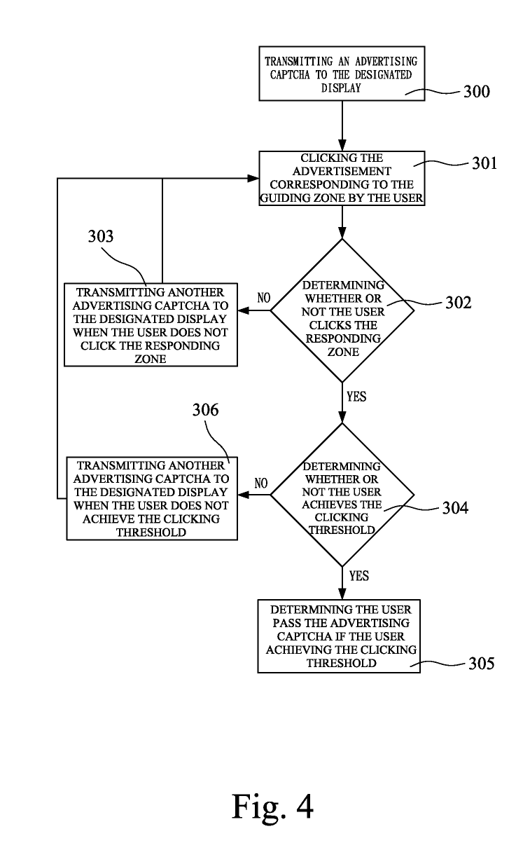

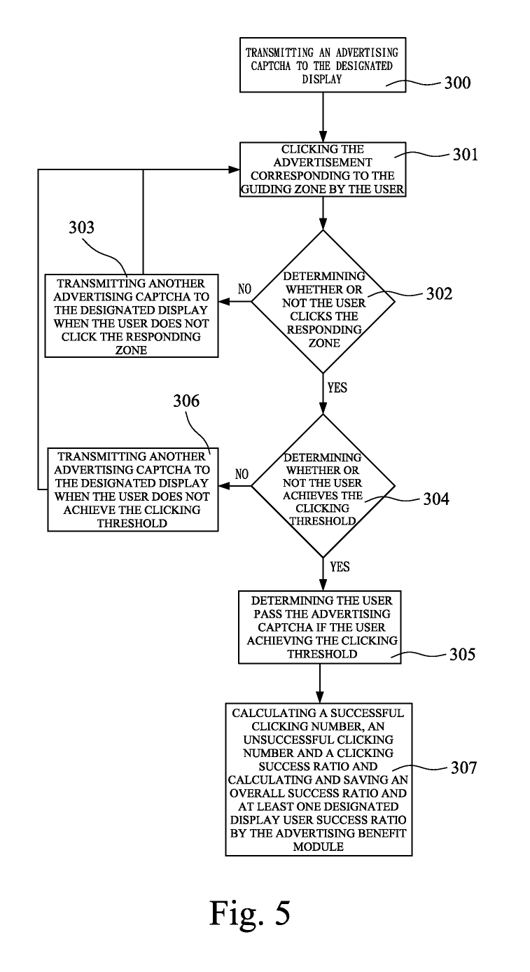

With reference to FIGS. 1, 3, 4 and 5, an advertising CAPTCHA method (3) in accordance with the present invention is used in a designated display (2) and a CAPTCHA server (10) with at least one user.

The CAPTCHA server (10) stores multiple advertising CAPTCHAs (100), has a clicking threshold and may comprise a CAPTCHA module (101) and an advertising benefit module (102).

Each advertising CAPTCHA (100) comprises an advertisement (1000), a guiding zone (1001) and may comprise an advertising information zone (1002).

The advertisement (1000) comprises a responding zone (10000) and may be a picture, a video or a motion picture.

The responding zone (10000) corresponds to the guiding zone (1001).

The advertising CAPTCHA method (3) comprises steps of (300) transmitting an advertising CAPTCHA (100) to the designated display (2), (301) clicking the advertisement (1000) corresponding to the guiding zone (1001) by the user, (302) determining whether or not the user clicks the responding zone (10000), (303) transmitting another advertising CAPTCHA (100) to the designated display (2) when the user does not click the responding zone (10000), (304) determining whether or not the user achieves the clicking threshold, (305) determining whether or not the user passes the advertising CAPTCHA (100) if the user achieves the clicking threshold, (306) transmitting another advertising CAPTCHA (100) to the designated display (2) when the user does not achieve the clicking threshold and optional step (307) calculating a successful clicking number, an unsuccessful clicking number and a clicking success ratio and calculating and saving an overall success ratio and at least one designated display user success ratio by the advertising benefit module (102).

The designated display (2) may be a web page or a program screen.

The clicking threshold may be 1 and be increased when the user clicks the responding zone (10000) unsuccessfully.

The advertising information zone (1002) may be a product linkage or information about a manufacturer.

In step (304) of determining whether or not the user achieves the clicking threshold is achieved by determining whether or not the user successively clicks the responding zone (10000) successfully or exceeds the clicking threshold.

In step (307) of calculating a successful clicking number, an unsuccessful clicking number and a clicking success ratio and calculating and saving an success ratio and at least one designated display user success ratio by the advertising benefit module (102), the successful clicking number is a number of times the user clicks the responding zone (10000) successfully.

The unsuccessful clicking number is a number of times the user clicks the responding zone (10000) unsuccessfully.

The clicking success ratio is a ratio of the successful clicking number to the unsuccessful clicking number, is calculated for each advertising CAPTCHA (100) and is transmitted to the advertising benefit module (102) by the CAPTCHA module (101).

The overall success ratio is a ratio of the successful clicking number to the unsuccessful clicking number of all users.

The designated display user success ratio is a ratio of the successful clicking number to the unsuccessful clicking number of all users in each designated display (2).

Various changes can be made without departing from the broad spirit and scope of the invention.

What is claimed is:

1. An advertising CAPTCHA system being used in a designated display with at least one user and comprising a CAPTCHA server connecting to the designated display, storing multiple advertising CAPTCHAs with each advertising CAPTCHA comprising an advertisement comprising a guiding zone and a responding zone corresponding to the guiding zone, comprising a CAPTCHA module having a clicking threshold, transmitting the advertising CAPTCHAs to the designated display, determining whether or not the user of the designated display clicks the responding zone and determining whether or not the user achieves the clicking threshold, the user passes the advertising CAPTCHA if the user achieves the clicking threshold, and the CAPTCHA server transmitting another advertising CAPTCHA to the designated display if the user does not achieve the clicking threshold.

2. The advertising CAPTCHA system as claimed in claim 1, wherein the designated display is a web page.

3. The advertising CAPTCHA system as claimed in claim 1, wherein the designated display is a program screen.

4. The advertising CAPTCHA system as claimed in claim 1, wherein the CAPTCHA server further comprises an advertising benefit module connected to the CAPTCHA module, further calculates a successful clicking number if the user clicks the responding zone successfully, an unsuccessful clicking number if the user calculates the responding zone unsuccessfully and a clicking success ratio being a ratio of the successful clicking number to the unsuccessful clicking number, being calculated by each advertising CAPTCHA and being transmitted to the advertising benefit module by the CAPTCHA module, the advertising benefit module calculating and saving an overall success ratio and at least one designated display user success ratio, the overall success ratio is a ratio of the successful clicking number to the unsuccessful clicking number of all users, the designated display user success ratio is a ratio of the successful clicking number to the unsuccessful clicking number of all users in each designated display.

5. The advertising CAPTCHA system as claimed in claim 1, wherein the clicking threshold is 1.

6. The advertising CAPTCHA system as claimed in claim 1, wherein the clicking threshold is increased when the user clicks the responding zone unsuccessfully.

7. The advertising CAPTCHA system as claimed in claim 1, wherein the CAPTCHA module determines a number if the user successively clicks the responding zone successfully or is over the clicking threshold.

8. The advertising CAPTCHA system as claimed in claim 1, wherein the advertising CAPTCHAs further comprises an advertising information zone being a product linkage.

9. The advertising CAPTCHA system as claimed in claim 1, wherein the advertising CAPTCHAs further comprise an advertising information zone being information about a manufacturer.

10. An advertising CAPTCHA method being used in a designated display and a CAPTCHA server with at least one user, the CAPTCHA server storing multiple advertising CAPTCHAs and having a clicking threshold, each advertising CAPTCHA comprising a guiding zone and an advertisement comprising a responding zone corresponding to the guiding zone, and comprising steps of
transmitting an advertising CAPTCHA to the designated display;
clicking the advertisement corresponding to the guiding zone by the user;
determining whether or not the user clicks the responding zone;
transmitting another advertising CAPTCHA to the designated display when the user does not click the responding zone;
determining whether or not the user achieves the clicking threshold;
determining whether or not the user passes the advertising CAPTCHA if the user achieves the clicking threshold; and
transmitting another advertising CAPTCHA to the designated display when the user does not achieve the clicking threshold.

11. The advertising CAPTCHA method as claimed in claim 10, wherein the designated display is a web page.

12. The advertising CAPTCHA method as claimed in claim 10, wherein the designated display is a program screen.

13. The advertising CAPTCHA method as claimed in claim 10, further comprises a step of calculating a successful clicking number, an unsuccessful clicking number and a clicking success ratio, the CAPTCHA server further comprises a CAPTCHA module and an advertising benefit module, the advertising benefit module calculating and saving an overall success ratio and at least one designated display user success ratio, the successful clicking number calculating a number if the user clicks the responding zone successfully, the unsuccessful clicking number calculating a number if the user clicks the responding zone unsuccessful, the clicking success ratio is a ratio of the successful clicking number to the unsuccessful clicking number, is calculated by each advertising CAPTCHA and is transmitted to the advertising benefit module by the CAPTCHA module, the overall success ratio is a ratio of the successful clicking number to the unsuccessful clicking number of all users, the designated display user success ratio is a ratio of the successful clicking number to the unsuccessful clicking number of all users in each designated display.

14. The advertising CAPTCHA method as claimed in claim 10, wherein the determining whether or not the user achieves the clicking threshold step determines whether the user successively click the responding zone successfully or exceeds the clicking threshold.

15. The advertising CAPTCHA method as claimed in claim 10, wherein the clicking threshold is 1.

16. The advertising CAPTCHA method as claimed in claim 10, wherein the clicking threshold is increased when the user clicks the responding zone unsuccessfully.

17. The advertising CAPTCHA method as claimed in claim 10, wherein the advertising CAPTCHAs further comprise an advertising information zone being a product linkage.

18. The advertising CAPTCHA method as claimed in claim 10, wherein the advertising CAPTCHAs further comprise an advertising information zone being information about a manufacturer.
